(19) United States
(12) Patent Application Publication
(10) Pub. No.: US 2021/0315205 A1
(43) Pub. Date: Oct. 14, 2021

(54) DICHALCOGENIDE TITANIUM OXIDE MATERIALS FOR DISINFECTION

(71) Applicants: Timothy Spence MCCOLGAN, St. Petersburg, FL (US); Madhu PANDEY, Clearwater, FL (US); Henry Adalberto ALEGRIA, Palm Harbor, FL (US); Manoj Kumar RAM, Palm Harbor, FL (US)

(72) Inventors: Timothy Spence MCCOLGAN, St. Petersburg, FL (US); Madhu PANDEY, Clearwater, FL (US); Henry Adalberto ALEGRIA, Palm Harbor, FL (US); Manoj Kumar RAM, Palm Harbor, FL (US)

(21) Appl. No.: 17/272,086

(22) PCT Filed: Aug. 27, 2019
(86) PCT No.: PCT/US2019/048338

§ 371 Date: Feb. 26, 2021

Related U.S. Application Data
(60) Provisional application No. 62/723,217, filed on Aug. 27, 2018.

(51) Int. Cl. A01N 25/26; A01N 59/16; A01N 59/02

(52) U.S. Cl. CPC A01N 25/26; A01N 59/02; A01N 59/16

(57) ABSTRACT

Particles comprising a core and a shell at least partially surrounding the core, wherein the core comprises a transition metal dichalcogenide and the shell comprises a transition metal oxide are disclosed. The particles can possess enhanced absorption of light in the visible and UVB/UVA spectrum, without inhibiting their inherent oxidative properties significantly. The particles inserted into a SODIS platform can possess equal or greater photocatalytic properties compared to the current TiO₂ SODIS method.

### BACKGROUND

Solar disinfection (SODIS) is recommended as a primary water purification process by the World Health Organization in conjunction with physical filtration methods. SODIS eliminates biological pathogens including bacteria, protozoans, and viruses through the combination of both light and heat. Proper employment of the SODIS process can greatly reduce mortality in children, the population most at risk from gastrointestinal diseases caused by waterborne Salmonella, Shigella, Escherichia Coli, and Vibrio Cholerae (Meierhofer, et al. Swiss Fed Inst Environ Sci Technol, Department of Water and Sanitation in Developing Countries. (2002). 1-80).

SODIS is non-electrical and relies on the generation of ozone (03) when the UV-A spectrum (320-400 nm) of sunlight reacts with aqueous Oxygen (O₂) (Id.). Dissolved O₂ molecules are split, forming oxygen free radicals (O.), which bond onto a nearby diatomic oxygen molecule. Ozone molecules have a high oxidation potential, making them deadly to waterborne microorganisms (Lonnen, et al. Water Res 39.5. (2005). 877-883). SODIS is applicable to international communities because it requires only simple materials, is portable, and can be employed at a household level (Meierhofer, et al. 2002). Although effective in optimal conditions, the SODIS method suffers from long purification times up to six hours, the necessity of unabated exposure to direct sunlight, and the potential of coliform regrowth during storage (Gelover, et al. Water Res 40.17. (2006). 3274-3280).

Improvements upon the SODIS method have naturally lead to the introduction of photocatalysts in the treatment process. Photocatalysts are materials which can speed the oxidation of bacteria through the generation of hydroxyl radicals (OH⁻) and oxide ions (O₂⁻) in drinking water, leading to a direct reduction in the decontamination time required by the SODIS process and preventing the regrowth of fecal coliform after treatment (Id.). The properties of the first nonelectrical photocatalyst, TiO₂, were discovered by Kenichi Honda and Akira Fujishima in 1972. Their research demonstrated that when TiO₂ was exposed to intense light, the generation of hydrogen gas was observed (Fujishima, et al. Nature 238. (1972). 27-38). This is because TiO₂ possesses the properties of a semiconductor. Semiconductors differ from metals and insulators due to their narrow band gap; band gap is a measurement of the energy required to excite a semiconductor and move an electron from bands closest to the nucleus (valence bands) to bands further from the nucleus (conduction bands) (Asahi, et al. Science 293.5528 (2001). 269-271). Metals have no band gap, which makes them excellent conductors of electricity as electrons move uninhibited from the valence to conduction bands. This differs from insulators, which have a band gap too large for the transmission of electrons. When electron movement occurs between the band gaps in a semiconducting material, a positive hole (h+) is formed in the valence band; this hole is responsible for the generation of hydrogen gas initially observed by Honda and Fujishima. H₂O molecules undergo hydrolysis at the h+ site into H⁺ and OH⁻ (Id.). In turn, the electron released into the conduction band reacts at the surface of the semiconductor with oxygen to form the oxide ion (O₂⁻). Both OH⁻ and O₂⁻ are powerful oxidizers that when dissolved within a solution can decrease the time required for disinfection. This is a decrease in time from over 80 minutes utilizing SODIS to 30 minutes for the complete elimination of fecal coliforms utilizing SODIS bottles coated with pure TiO₂ (Gelover et al., 2006). The band gap of TiO₂ is 3.19 eV (electron volts) (Asahi, 2001), and is calculated by the following formula:

$$E ( eV ) = \frac{hc}{λ} = \frac{( 4.135667516 \cdot {10}^{- 15} eV s ) ( 299792458 m / s )}{λ ( nm )} = \frac{1239.84192 eV \cdot nm}{λ ( nm )}$$

where E (eV) is calculated by multiplying Planck's constant (h) by the speed of light (c) in a vacuum, and dividing it by the longest wavelength of light absorbed by the semiconductor (λ) causing photoexcitation. Due to the 3.19 eV band gap of TiO₂, only wavelengths shorter than 388 nm mediate this process (Carp, et al. Prog Solid State Chem 32.1-2. (2004). 33-177). Thus, the utilization of pure TiO₂ for SODIS is limited by the availability of UV light, which comprises at most only 3-5% of total sunlight hitting the earth due to filtration by the ozone layer (Emery, American Society for Testing and Materials (ASTM) Terrestrial Reference Spectra for Photovoltaic Performance Evaluation. (2002). 1-20). Concurrently, peak absorbance of UV light by TiO₂ occurs at 150 nm, 200 nm, and 240 nm, with significantly lower absorbance in the UVB/UVA range of 290-400 nm. The largest absorbance peaks of TiO₂ occur in the UVC wavelength, which is filtered completely from sunlight as it travels through the ozone layer and atmosphere.

Because of the absorbance limitations of TiO₂, a significant body of research has been generated in finding a way to reduce its band gap energy (Diebold, Surface Sci Reports 48.5-8. (2003). 53-229). Reduction in band gap energy (eV) can extend the wavelength of light absorbed by TiO₂ into the visible range as well as increase intensity of absorbance in the UVB/UVA regions, which penetrate the ozone layer (Gunti, et al. Am J Anal Chem. (2016). 576-587). By doing this, the photocatalytic potential of TiO₂ can be exponentially increased (Diebold, 2003). This reduction can be accomplished by doping the crystal lattice structure of a semiconductor; doping is a process regularly employed in the creation of materials for use in diodes and transistors within the electronics manufacturing industry (Chen, et al. Chemical reviews 110.11. (2010). 6503-6570). Doping is done in order to increase the number of charge carriers in the crystal through the formation of semiconductor junctions, as well as lowering electrical resistance. An increase in charge carriers on the surface of crystal means that a greater number of positive holes (H+) and released electrons can be generated, increasing oxidative potential (Chen et al., 2010). Doping of TiO₂ has been successfully tested with many metals and metal oxides, including Molybdenum (Diebold, 2003). Doping of TiO₂ to yield nanocomposites has been demonstrated to both extend and increase the intensity of absorbance of TiO₂ by reducing the band gap (Zhang, et al. Canadian J Chem Eng 93.9. (2015). 1594-1602). What are needed are new compositions and methods for performing SOIDS, especially with visible light. The compositions and methods disclosed herein address these and other needs.

### SUMMARY

In accordance with the purposes of the disclosed subject matter, as embodied and broadly described herein, this disclosure, in one aspect, relates to particles comprising a core and a shell at least partially surrounding the core, wherein the core comprises a transition metal dichalcogenide and the shell comprises a transition metal oxide. The disclosed particles can possess enhanced absorption of light in the visible and UVB/UVA spectrum, without inhibiting their inherent oxidative properties significantly. The disclosed particles inserted into a SODIS platform can possess equal or greater photocatalytic properties compared to the current TiO₂ SODIS method.

Additional aspects and advantages of the disclosure will be set forth, in part, in the detailed description and any claims which follow, and in part will be derived from the detailed description or can be learned by practice of the various aspects of the disclosure. The advantages described below will be realized and attained by means of the elements and combinations particularly pointed out in the appended claims. It is to be understood that both the foregoing general description and the following detailed description are exemplary and explanatory only and are not restrictive of the disclosure.

### BRIEF DESCRIPTION OF DRAWINGS

The accompanying figures, which are incorporated in and constitute a part of this specification, illustrate several aspects described below.

FIG. 1 is an XRD overlay of the three concentrations of MoS₂ doped TiO₂.

FIG. 2 is an XRD readout of pure MoS₂ standard (Wildervanck and Jellinek, 1964).

FIG. 3 is an XRD readout of pure TiO₂ standard (Sanchez et al., 1996).

FIG. 4 is an XRD analysis of 1.5% MoS₂-98.5% TiO₂.

FIG. 5 is an XRD analysis of 5% MoS₂-95% TiO₂.

FIG. 6 is an XRD analysis of 10% MoS₂-90% TiO₂.

FIG. 7 is an UV-Vis analysis overlay of the three batches MoS₂—TiO₂.

FIG. 8 is an FTIR analysis overlay of synthesized batches and chemical standards.

FIG. 9 is an SEM image of 1.5% MoS₂-98.5% TiO₂.

FIG. 10 is an SEM image of TiO₂ nanoparticles (Chenari et al., 2016).

FIG. 11 is a first SEM image of 5% MoS₂-95% TiO₂.

FIG. 12 is an SEM image of bulk mono-layered MoS₂ flakes (Forsberg et al., 2016).

FIG. 13 is a second SEM image of 5% MoS₂-95% TiO₂.

FIG. 14 is a first SEM image of 10% MoS₂-90% TiO₂.

FIG. 15 is a second SEM image of 10% MoS₂-90% TiO₂ SEM.

FIG. 16 depicts the experimental SODIS platform with bottles and pyranometer.

FIG. 17 depicts the E. coli culture vials undergoing incubation and mixing.

FIG. 18 depicts the E. coli cultures in LB broth post incubation versus sterile broth.

FIG. 19 depicts the E. coli bacterial pellet immediately prior to resuspension.

FIG. 20 is a graphic representation of plate counts for no insert.

FIG. 21 is a graphic representation of agar plate counts for pure TiO₂.

FIG. 22 is a graphic representation of agar plate counts for 1.5% MoS₂-98.5% TiO₂.

FIG. 23 is a graphic representation of agar plate counts for 5% MoS₂-95% TiO₂.

FIG. 24 is a graphic representation of agar plate counts for 10% MoS₂-90% TiO₂.

FIG. 25 is a Pyranometer readout for pure TiO₂.

FIG. 26 depicts Agar plate counts for pure TiO₂.

FIG. 27 is a Pyranometer readout for 1.5% MoS₂-98.5% TiO₂.

FIG. 28 depicts Agar plate counts for 1.5% MoS₂-98.5% TiO₂.

FIG. 39 is a Pyranometer readout for 5% MoS₂-95% TiO₂.

FIG. 30 depicts Agar plate counts for 5% MoS₂-95% TiO₂.

FIG. 31 is a Pyranometer readout for 10% MoS₂-90% TiO₂.

FIG. 32 depicts Agar plate counts for 10% MoS₂-90% TiO₂.

FIG. 33 is a Pyranometer readout for no insert.

FIG. 34 depicts Agar plate counts for no insert.

Like reference symbols in the various drawings indicate like elements.

### DETAILED DESCRIPTION

The inventors have utilized particles of transition metal oxide doped with transition metal dichalcogenide to increase the effectiveness of the SODIS process. The materials, compounds, compositions, articles, and methods described herein may be understood more readily by reference to the following detailed description of specific aspects of the disclosed subject matter and the Examples and Figures included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence upon which the reference is relied.

### Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a particle” includes mixtures of two or more such particles, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values can be used.

As used herein, the term “composition” is intended to encompass a product comprising the specified ingredients in the specified amounts, as well as any product which results, directly or indirectly, from combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight component Y, X and Y are present at a weight ratio of 2:5, and are present in such ratio regardless of whether additional components are contained in the mixture.

A weight percent (wt. %) of a component, unless specifically stated to the contrary, is based on the total weight of the formulation or composition in which the component is included.

### Particles

In accordance with the purpose of the disclosed methods, as embodied and broadly described herein, the disclosed subject matter relates to particles and methods of making the disclosed particles. One aspect concerns a particle comprising a core and a shell at least partially surrounding the core, wherein the core comprises a transition metal dichalcogenide and the shell comprises a transition metal oxide. In some examples, the disclosed particles can consist of a transition metal dichalcogenide core and a transition metal oxide shell. In other examples, the disclosed particles can consist essential of a transition metal dichalcogenide core and a transition metal oxide shell.

The term “core” refers to an interior portion or region of a particle. The term “shell” refers to an outer or exterior layer or region of a particle. The term “shell at least partially surrounding the core” refers to a shell wherein at least a part of the shell forms a layer over or on at least part of the core. This core/shell structure is to be contrasted with a particle having a homogeneous distribution of materials throughout, e.g., an alloy.

In the disclosed particles, the core of the particle can comprise a transition metal dichalcogenide. In some embodiments, the transition metal dichalcogenide can have the formula MX₂, wherein M is Ti, Mo, In, W, Fe, Mn, Pd, Ta, Zr, or Cu, and wherein X is O, S, Se, or Te. In some embodiments, the transition metal dichalcogenide is MoS₂, MoSe₂, MoTe₂, WS₂, WSe₂, WTe₂, FeS₂, FeSe₂, FeTe₂, MnS₂, MnSe₂, MnTe₂, CuS₂, CuSe₂, CuTe₂, PdS₂, PdSe₂, PdTe₂, or combinations thereof. In specific examples, the transition metal dichalcogenide is MoS₂.

In the disclosed particles, the shell of the particle can comprise a transition metal oxide. In some embodiments the transition metal oxide can be a transition metal monoxide, dioxide, trioxide, ternary oxide, binary oxide. In some embodiments the transition metal oxide is TiO₂. In further examples, the transition metal oxide can be ZnO, MnO, WO₃, Fe₂O₃, In₂O₃, CuO₂, PdO₂, Ta₂O₅, TiO₂, ZrO₂, and combinations thereof.

In specific examples, the disclosed particles can comprise a TiO₂ shell at least partially surrounding a core comprising one or more of MoS₂, MoSe₂, MoTe₂, WS₂, WSe₂, WTe₂, FeS₂, FeSe₂, FeTe₂, MnS₂, MnSe₂, MnTe₂, CuS₂, CuSe₂, CuTe₂, PdS₂, PdSe₂, PdTe₂, or combinations thereof.

The thickness of the shell around the core can be 10 nm or greater, 20 nm or greater, 30 nm or greater, 40 nm or greater, 50 nm or greater, 100 nm or greater, 150 nm or greater, 200 nm or greater, 250 nm or greater, 300 nm or greater, 500 nm or greater, 750 nm or greater, 1 micron or greater, 2 microns or greater, 3 microns or greater, 4 microns or greater, or 5 microns or greater. The thickness of the shell around the core can be 10 microns or less, 9 microns or less, 8 microns or less, 5 microns or less, 3 microns or less, 2 microns or less, 1 micron or less, 900 nm or less, 750 nm or less, 600 nm or less, 500 nm or less, 300 nm or less, 250 nm or less, 200 nm or less, 150 nm or less, 100 nm or less, 90 nm or less, 80 nm or less, 50 nm or less, or 25 nm or less. The thickness of the shell around the core can be from 10 nm to 10 micrometers, e.g., from 10 nm to 100 nm, from 100 nm to 1 micrometer, from 1 micrometer to 10 micrometers, and the like.

The shell can be in the form of particles, that is, the shell can be a layer of particles at least partially surrounding the core. The particles in the shell can have an average particle size of 10 nm or greater, 20 nm or greater, 30 nm or greater, 40 nm or greater, 50 nm or greater, 100 nm or greater, 150 nm or greater, 200 nm or greater, 250 nm or greater, 300 nm or greater, 500 nm or greater, 750 nm or greater, 1 micron or greater, 1.5 microns or greater, 2 microns or greater, 3 microns or greater, 4 microns or greater, or 5 microns or greater. The particles in the shell can have an average particle size of 10 microns or less, 9 microns or less, 8 microns or less, 5 microns or less, 3 microns or less, 2 microns or less, 1 micron or less, 900 nm or less, 750 nm or less, 600 nm or less, 500 nm or less, 300 nm or less, 250 nm or less, 200 nm or less, 150 nm or less, 100 nm or less, 90 nm or less, 80 nm or less, 50 nm or less, or 25 nm or less. The particles in the shell can have an average particle size from 10 nm to 10 micrometers, e.g., from 10 nm to 100 nm, from 100 nm to 1 micrometer, from 750 nm to 1.5 micrometer, from 900 nm to 1.2 micrometer, from 1 micrometer to 10 micrometers, and the like. In some embodiments, the shell is a layer of microparticles. In some examples, microparticles in the shell have a particle size of about 1 micrometer.

In some embodiments, the shell comprises 90 wt. % or greater, of the particle. For example, the shell comprises 91 wt. % or greater, 92 wt. % or greater, 93 wt. % or greater, 94 wt. % or greater, 95 wt. % or greater, 96 wt. % or greater, 97 wt. % or greater, 98 wt. % or greater, 98.5 wt. % or greater, or 99 wt. % or greater, of the particle. In some examples, the shell comprises from 90 to 98.5 wt. % of the particle. For example, the shell can comprise 90, 91, 92, 93, 94, 95, 96, 97, 98 or 98.5 wt. % of the particle, where any of the stated values can form an upper or lower endpoint of a range. In some embodiments, the shell ranges from 90 to 99 wt. % of the particle, from 90 to 95 wt. % of the particle, from 91 to 96 wt. % of the particle, from 92 to 97 wt. % of the particle, or from 95 to 98.5 wt. % of the particle.

The core comprising the transition metal dichalcogenide can make up 1.5 wt % or greater of the particle. For example, the core can make up 2 wt % or greater, 2.5 wt % or greater, 3 wt % or greater, 3.5 wt % or greater, 4 wt % or greater, 4.5 wt % or greater, 5 wt % or greater, 6 wt % or greater, 7 wt % or greater, 8 wt % or greater, 9 wt % or greater, or 10 wt % or greater, of the particle. In some embodiments, the core comprises 10 wt % or less, 9 wt % or less, 8 wt % or less, 7 wt % or less, 6 wt % or less, 5 wt % or less, 4 wt % or less, 3.5 wt % or less, 3 wt % or less, 2.5 wt % or less, 2 wt % or less, 1.5 wt % or less, or 1 wt % or less, of the particle. For example, the core can comprise 1, 2, 3, 4, 5, 6, 7, 8, 9, or 10 wt. % of the particle, where any of the stated values can form an upper or lower endpoint of a range. In some embodiments, the core can be from 1 to 5 wt. % of the particle, from 1.5 to 5 wt. % of the particle, from 2 to 6 wt. % of the particle, from 3 to 7 wt. % of the particle, or from 5 to 10 wt. % of the particle.

In some embodiments, the core is 1.5 wt. % and the shell is 98.5 wt. % of the particle. In some embodiments, the core is 5 wt. % and the shell is 95 wt. % of the particle. In further embodiments, the core is 10 wt. % and the shell is 90 wt. % of the particle.

In some embodiments, the core can be a mono-layered flake having a longest dimension of 1 micron or greater, 2 microns or greater, 3 microns or greater, 4 microns or greater, 4 microns or greater, 5 microns or greater, 6 microns or greater, 7 microns or greater, 8 microns or greater, 9 microns or greater, 10 microns or greater, 12 microns or greater, 14 microns or greater, 15 microns or greater, 16 microns or greater, 18 microns or greater, or 20 microns or greater. In some embodiments, the core can be a mono-layered flake having a longest dimension of 20 microns or less, 18 microns or less, 15 microns or less, 12 microns or less, 10 microns or less, 9 microns or less, 8 microns or less, 7 microns or less, 6 microns or less, 5 microns or less, 4 microns or less, 3 microns or less, 2 microns or less, or 1 micron or less. In some embodiments, the core can be a mono-layered flake having a longest dimension of from about 1 to 20 micrometers. In some embodiments, the core is a mono-layered flake having a longest dimension from about 5 to about 10 micrometers.

In some embodiments, the disclosed particles can be generally spherical. In other embodiments, the disclosed particles can be irregularly shaped. The disclosed particles comprising a core and a shell can have a longest dimension of 1 micron or greater, 2 microns or greater, 3 microns or greater, 4 microns or greater, 4 microns or greater, 5 microns or greater, 6 microns or greater, 7 microns or greater, 8 microns or greater, 9 microns or greater, 10 microns or greater, 12 microns or greater, 14 microns or greater, 15 microns or greater, 16 microns or greater, 18 microns or greater, or 20 microns or greater. In some embodiments, the disclosed particles can have a longest dimension of 20 microns or less, 18 microns or less, 15 microns or less, 12 microns or less, 10 microns or less, 9 microns or less, 8 microns or less, 7 microns or less, 6 microns or less, 5 microns or less, 4 microns or less, 3 microns or less, 2 microns or less, or 1 micron or less. In some embodiments, the disclosed particles can have a longest dimension of from about 1 to 20 micrometers, e.g., 1, 5, 10, 15, or 20 micrometers, where any of the stated values can form an upper or lower endpoint of a range. In certain examples, the disclosed particles can be from 1 to 10 micrometers, from 5 to 15 micrometers, from 10 to 20 micrometers, from 1 to 5 micrometers, from 5 to 10 micrometers, from 10 to 15 micrometers, or from 15 to 20 micrometers.

### Methods of Making

Also disclosed herein are methods of making the disclosed particles. The disclosed methods can comprise, for example, contacting a transition metal alkoxide with a suspension of a core material comprising a transition metal dichalcogenide, thereby forming a sol-gel precursor solution; and acidifying the suspension, thereby surrounding at least part of the core with a shell comprising a transition metal oxide.

In some embodiments, the transition metal dichalcogenide can have the formula MX₂, wherein M is Ti, Mo, W, In, Fe, Mn, Pd, Ta, Zr, or Cu, and wherein X is O, S, Se, or Te. In some embodiments, the transition metal dichalcogenide is MoS₂, MoSe₂, MoTe₂, WS₂, WSe₂, WTe₂, FeS₂, FeSe₂, FeTe₂, MnS₂, MnSe₂, MnTe₂, CuS₂, CuSe₂, CuTe₂, PdS₂, PdSe₂, PdTe₂, or combinations thereof.

In some embodiments the transition metal alkoxide is M[C₁₋₆ alkoxide]ₓ, where M is Ti, Mo, W, In, Fe, Mn, Pd, Ta, Zr, or Cu, x is an integer of from 1 to 10, e.g., from 1 to 4, from 2 to 6, from 2 to 4. In some embodiments the transition metal alkoxide is Ti[OCH(CH₃)₂]₄. In other examples, the transition metal alkoxide is Mn[OCH(CH₃)₂]₂, Zr(OCH₂CH₃)₄, Ta₂(OCH₂CH₃)₁₀.

In some embodiments, the method further comprises an initial step, occurring prior to contacting a transition metal alkoxide with a suspension of a core, comprising: sonicating a suspension of a transition metal dichalcogenide in a solvent and a surfactant, thereby forming a suspension of transition metal dichalcogenide monolayers. In some embodiments, the solvent is anhydrous 2-isopropanol. In some embodiments, the surfactant is polystyrene sulfonate, cetrimonium bromide, dimethyldioctylammonium chloride, polydodecylsulfonate, cetylpyridinium chloride, or a polyacid.

In some embodiments, contacting a transition metal alkoxide with a suspension of a core comprising a transition metal dichalcogenide further comprises sonication.

In some embodiments, acidifying the suspension comprises contacting the suspension with concentrated hydrochloric acid.

In some embodiments, the method further comprises diluting the suspension to precipitate the particle. In some embodiments, the method further comprises washing the particle to remove the surfactant and the solvent. In some embodiments, the method further comprises drying and annealing the particle. In some embodiments, the method further comprises milling the particle.

### Articles and Methods of Making

Also disclosed herein are articles comprising the particles disclosed herein, a support, and an adhesive layer positioned between the support and the particles.

In some embodiments, the support can be an acetate film. In other examples, the support can be a metal or metal oxide such as TiO₂, NiO, SnO₂, or ZnO. Further examples of suitable supports include, without limitation, glass, metal-coated glass, polymer materials, metal-coated polymers, metal, metal alloy, quartz, paper, nanowires, and nanotubes. Examples of polymer materials are polyalkylenes, polyesters, polyamides, polycarbonates, and polyalkoxyls. In specific examples, the substrate can be Mo-coated glass, Au-coated glass, Ni-coated glass, indium tin oxide-coated glass, Mo-coated polyethylene terephthalate, Au-coated polyethylene terephthalate, Ni-coated polyethylene terephthalate, indium tin oxide-coated polyethylene terephthalate, non-woven indium tin oxide, or any other suitable material. In specific examples, the support can be a metal or metal coated substrate

In some embodiments, the adhesive layer can be a polyester resin, silicone resin, epoxy resin, vulcanized rubber, polyurethane resin, or high-density polyethylene.

Also disclosed herein are methods of making articles. In one aspect, a method of producing an article comprises coating a support with a layer of adhesive; coating the adhesive layer with a particle as disclosed herein; and curing the article in the dark. In some embodiments, the method further comprises storing the article in an environment with reduced exposure to oxygen and light.

### Methods of Reducing Microbial Contamination

Also disclosed herein are methods of reducing microbial contamination. By “reduce” or other forms of the word, such as “reducing” or “reduction,” is meant lowering of a characteristic (e.g., colony forming units per volume). It is understood that this is typically in relation to some standard or expected value, in other words it is relative, but that it is not always necessary for the standard or relative value to be referred to. For example, “reducing microbial contamination” means reducing the colony forming units per unit volume of a microbe in a sample relative to a standard or a control.

Further disclosed herein are methods of reducing organic contamination. For example, the disclosed methods can be used to reduce the amount of dyes, pesticides, herbicides, polymers, plasticizers, and the like from a sample.

In one aspect, the disclosed methods comprise contacting a contaminated sample with the particles disclosed herein and light. In another aspect, the disclosed methods comprise contacting a contaminated sample with the articles disclosed herein and light. The light can be visible light. In specific examples, the light can be UVB/UVA. In some embodiments, the light can be solar radiation. The disclosed methods advantageously provides methods of reducing microbial contamination using light independent of a specific wavelength (e.g., 365 nm which is required for TiO₂ nanomaterials). Accordingly, the methods disclosed herein can use solar radiation in reducing the microbial contamination.

In some embodiments, the disclosed methods can reduce microbial contamination by at least 25% within 60 minutes. In some embodiments, the disclosed methods can reduce microbial contamination by at least 50% within 90 minutes. In some embodiments, the disclosed methods can reduce microbial contamination by at least 75% within 120 minutes. In some embodiments, the disclosed methods can reduce microbial contamination by at least 90% within 150 minutes.

In some embodiments, the microbial contamination is due to a bacterial contamination. Examples of microbial contamination that can be reduced by the disclosed particles and methods include, but are not limited to, Streptococcus mutans, Streptococcus salivarius, Streptococcus sanguis, Staphylococcus aureus, Staphylococcus epidermidis, Staphylococcus haemolyticus, S. Staphylococcus hominis, Staphylococcus simulans, methicillin-resistant [MRSA] or methicillin-susceptible staphylococci, Enterococcus faecalis, Enterococcus faecium, Clostridium deficile, Candida albicans, Candida dubliniensis, Candida glabrata, Candida gullermondii, Candida pseudotropicalis, Candida krusei, Candida lusitaniae, and Candida tropicalis.

In some embodiments, the disclosed methods can reduce organic contamination by at least 25% within 60 minutes. In some embodiments, the disclosed methods can reduce organic contamination by at least 50% within 90 minutes. In some embodiments, the disclosed methods can reduce organic contamination by at least 75% within 120 minutes. In some embodiments, the disclosed methods can reduce organic contamination by at least 90% within 150 minutes.

In some embodiments, the contaminated sample is liquid. For example, the sample can be an aqueous sample such as drinking water, or water from a stream or lake, or rain water. In some embodiments, the contaminated sample is gaseous. In some embodiments, the contaminated sample is solid.

In some embodiments, the light comprises ultraviolet light. In some embodiments, the light comprises visible light. In other embodiments, the light is UVB/UVA light. The particular time and extent of exposure can be varied depending on the size of the sample, the degree of contamination, the wavelength of light, the intensity of light, and the like.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### EXAMPLES

The following examples are set forth below to illustrate the methods, compositions, and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

Plating and Culturing of Escherichia coli (E. coli)

A stock solution of agar broth suitable for plating was prepared by mixing 25 grams of LB broth powder and 15 grams of granulated agar in 1 liter of water in a 2-liter flask containing a stir bar. With stirring, the mixture was brought to a boil and then removed from heat. The flask containing the mixture was then sterilized in an autoclave for 20 minutes at 15 PSI. The flask was removed from the autoclave and the solution was cooled to 50° C. Then, the solution was transferred to sterile petri dishes in 20 ml aliquots. The dishes were then placed in a laminar flow fume hood, where they set for 24 hours. After this period, the agar plates were placed in zip-lock bags and refrigerated until use.

Culturing of E. coli

An LB broth stock solution was prepared by adding 25 grams of LB broth powder to 1 liter of deionized water within an autoclave-safe glass bottle. The mixture was autoclaved for 20 minutes at 15 PSI to disinfect the solution. K12 strain E. coli cultured on agar was obtained from Carolina Biological Supply Co. A suspension was prepared by transferring 50 μL of the bacterial culture into 10 mL of LB broth within eight brown glass 30 mL culture vials. The silicone injection ports of the culture tubes were removed and replaced with sterile medical cotton wrap secured by screw cap to allow for the flow of air. The cultures were then allowed to colonize for 24 hours at 37° C. within an incubation chamber secured atop an orbital shaker for constant mixing. After incubation, the culture vials were wrapped in aluminum foil and refrigerated to prevent contamination of the cultures.

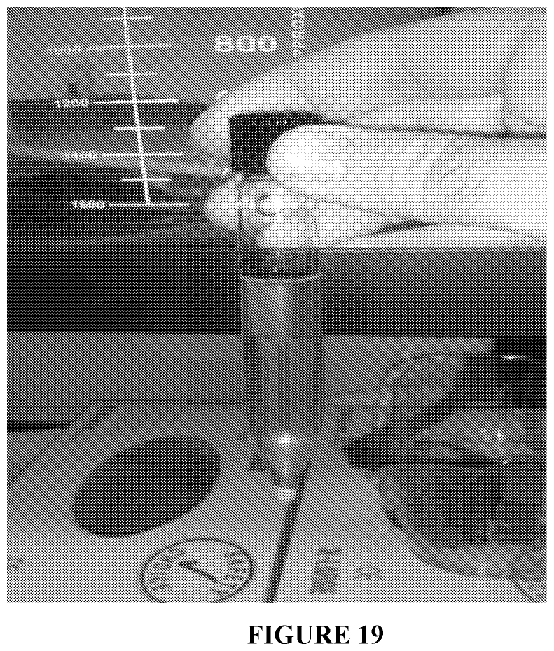

Immediately prior to use in experimentation, the E. coli bacterial culture was separated from the LB broth. This was achieved by transferring one of the liquid culture vials to a centrifuge tube. The mixture was centrifuged for 5 minutes at 1500 rpm, yielding a bacterial pellet from which the broth could be discarded (FIG. 19). The broth was then replaced by 10 mL of 0.85% Saline solution and agitated thoroughly by a vortex mixer to break up and suspend the bacterial pellet. One-mL aliquots of this solution were utilized per bottle during the experimentation phase.

100 μL of the resuspended E. coli solution in saline was added to a second centrifuge tube containing 9.9 mL of 0.89% saline solution and agitated for homogeneity. This was again diluted by removing 1 ml of solution from the second tube and transferring it to a third centrifuge tube containing 9 mL of 0.89% saline solution. The second and third test centrifuge had 100× and 1000× dilutions, respectively. This dilution was performed to achieve a target concentration of 300 to 3000 colony forming units per milliliter. 100 μL of solution from the second and third centrifuge tubes were plated in duplicate onto agar and counted. While the 100× dilution was too numerous to count, the 1000× dilution yielded a viable count at an average of 97 colonies per plate, or 970 colony CFU/ml at a 1000× dilution. Thus, it can be expected that taking 1 mL of saline culture and diluting with 999 mL of deionized water would yield an initial count of bacteria between 30 and 300, if 100 μL samples were taken and plated prior to disinfection. Thus, a 1000× dilution factor was employed for testing when taken from the stock cultures of E. coli.

### Preparation of Nanomaterial Catalyst Inserts

Catalyst inserts were prepared by immobilizing MoS₂—TiO₂ nanomaterials on acetate sheets using a silicone adhesive. The same process was also used to prepare a control insert without nanomaterial and a control insert with pure TiO₂ nanomaterial. First, a coat of clear silicone sealant was brushed across a clear acetate sheet using bristle brushes. A sieve was used to evenly spread the nanomaterial powder across the sheet to fully coat the silicone. Excess powder was shaken off, and the silicone coating was cured in the dark for 24 hours. The resulting film coating was resistant to water and powdered nanomaterial did not wash off upon exposure of the insert to water. Catalyst inserts were cut to size (8.5×5 inches) and stored in aluminum foil to prevent potential oxidation or photodegradation.

A solar disinfection platform was produced by rolling up the catalyst insert and placing it into a one-liter polyethylene terephthalate bottle, such that when the bottle was laid horizontally on its side, the insert covered the upper half of the internal surface of the bottle with the coating facing the interior of the bottle.

### Evaluation of Nanomaterial Catalyst Efficacy

First, an E. coli saline culture averaging about 970 colony CFU/mL was prepared (described above). Next, two solar disinfection platforms (described above) were each filled to the 1-liter mark with deionized water. Then, 1 mL aliquots of E. coli saline culture were drawn up using an autopipette and injected into each bottle. Each bottle was agitated to distribute the bacteria. An initial bacterial count for each bottle was taken by drawing up a 100 μL aliquot of water using an autopipette and depositing it dropwise onto an agar plate. The droplets were then distributed on the agar using a sterilized inoculating loop.

Each bottle was placed insert side up underneath a Chromalux 100 W full spectrum (UVA/UVB) bulb calibrated not to exceed an intensity of 1000 W/m² (comparable to direct overhead sunlight) using an SP-215 Apogee Precision Amplified Pyranometer coupled with Vernier light intensity monitoring software.

The disinfection procedure was then run for four hours, sampling and plating both bottles in 100 μL aliquots every 30 minutes from the beginning of experimentation. At the end of the experiment, the agar plates were placed into an incubation chamber set at 37° C. for 24 hours. At the end of the incubation chamber, the number of CFU's on each plate was counted and photographed. The percent decrease for each time period was calculated as:

Z %=½*[Abs(N_{1(T)}−N_{(1(T+30)})/N_{1(T)}+Abs(N_{2(T)}−N_{2(T+30)})/N_{2(T)}]*100

where N₁=bottle #1 CFU/100 μL, N₂=bottle #2 CFU/100 μL and T=time of sample collection.

### Comparative Example 1: Water Disinfection with No Nanomaterial Catalyst

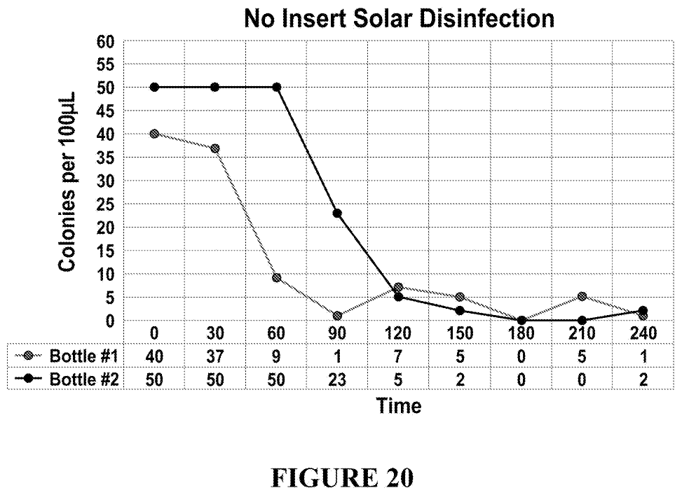

Bottle #1 had a recorded starting colony count of 400 CFU/mL, with bottle #2 registering at 500 CFU/ml. Both starting counts were within desired experimental ranges. Bottle #1 dropped the most significantly between the 30- to 90-minute sampling windows, from 370 CFU/ml all the way down to 10 CFU/ml. An increased colony count was recorded in the sampling period immediately afterwards, with 70 CFU/mL at the 120-minute sampling period. In comparison, bottle #2 did not register a decrease in colony counts until after the 60-minute sampling time. Between 60 and 120 minutes bottle #2 decreased in viable colonies the most from 50 colonies down to 5, which is a 90% decrease. Full disinfection was recorded at 180 minutes, with both bottles recorded at a 0-colony count at this sampling time. Despite this result at the three-hour mark, these results were contraindicated by a high plate count of 50 CFU/mL at the 210-minute mark for bottle #1. The results are shown in FIG. 20 and Table 1.

### Comparative Example 2: Water Disinfection Using Pure TiO₂ Nanomaterial Catalyst

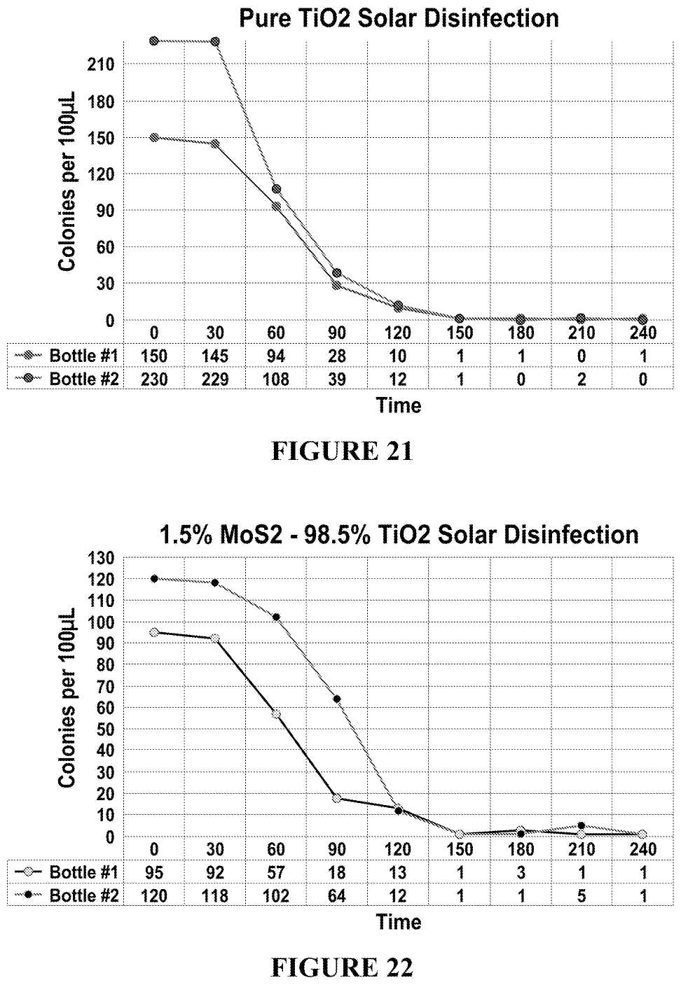

The starting colony count for bottle #1 was 1500 CFU/mL, with bottle #2 at 2300 CFU/mL; these values were within the experimental goal range of 300 to 3000 CFU/mL. For both bottles, the timeframe of greatest colony decrease occurred between the 30 to 90-minute sampling periods. Bottle #2 experienced the highest rate of disinfection during this time with an 81% decrease in viable CFU's between 30-90 minutes. By the 60-minute sampling time, both bottles displayed a similar level of colonies (#1 940 CFU/mL, #2 1080 CFU/mL), despite bottle #2 starting with a colony count 800 CFU/mL higher than bottle #1. The sample bottles continued this trend of similar colony counts through the remainder of the experiment, with both bottles reaching baseline (10 CFU/mL) by the 150-minute sampling mark. These results indicate that bottle #1 went from a total number of bacteria around 1.5 million, and bottle #2 a total of 2.3 million, to less than 10,000 bacteria per bottle within 150 minutes, demonstrating that pure TiO₂ nanomaterial catalyst serve as an effective addition to SODIS. The results are shown in FIG. 21 and Table 1.

### Example 1: 1.5 wt. % MoS₂-98.5 wt. % TiO₂ Nanomaterial

730 mL anhydrous 2-propanol and 100 mg cetyltrimethylammonium bromide were added into a 2-liter flask. 600 mg finely powdered MoS₂ (3.75 mmol) was suspended in the solution with stirring. 146 mL Ti[OCH(CH₃)₂]₄ (493 mmol) was pipetted into the flask while placed in a sonication bath. 750 mL of deionized water acidified to pH 2 with concentrated hydrochloric acid was added dropwise with vigorous stirring. At this stage, Ti[OCH(CH₃)₂]₄ was hydrolyzed into TiO₂, incorporating the suspended MoS₂ particles. The MoS₂—TiO₂ nanomaterial suspension was stirred for 24 hours., then transferred to a 4-liter flask. After deionized water was added to the nanomaterial suspension to the 4-liter mark, MoS₂—TiO₂ nanomaterial precipitated to the bottom of the flask while surfactant and 2-propanol remained in solution. After complete settling, 3 liters of water were drawn off from above the settled product and discarded. This process was repeated a total of 10 times to ensure that surfactant and 2-propanol had been fully removed from the MoS₂—TiO₂ nanomaterial. Next, the solution volume was reduced to 500 mL through settling of the MoS₂—TiO₂ nanomaterial. 50 mL aliquots of nanomaterial suspension were transferred to evaporation dishes and dried in an oven at 100° C. for 24 hours to anneal and fully dehydrate the powder. Each batch was then finely powdered for 20 minutes within a Fritsch Pulverisette ball mill using zirconium pellets to ensure finely milled particles optimized for use as a photocatalyst. The actual yield was 38.5 g (96%).

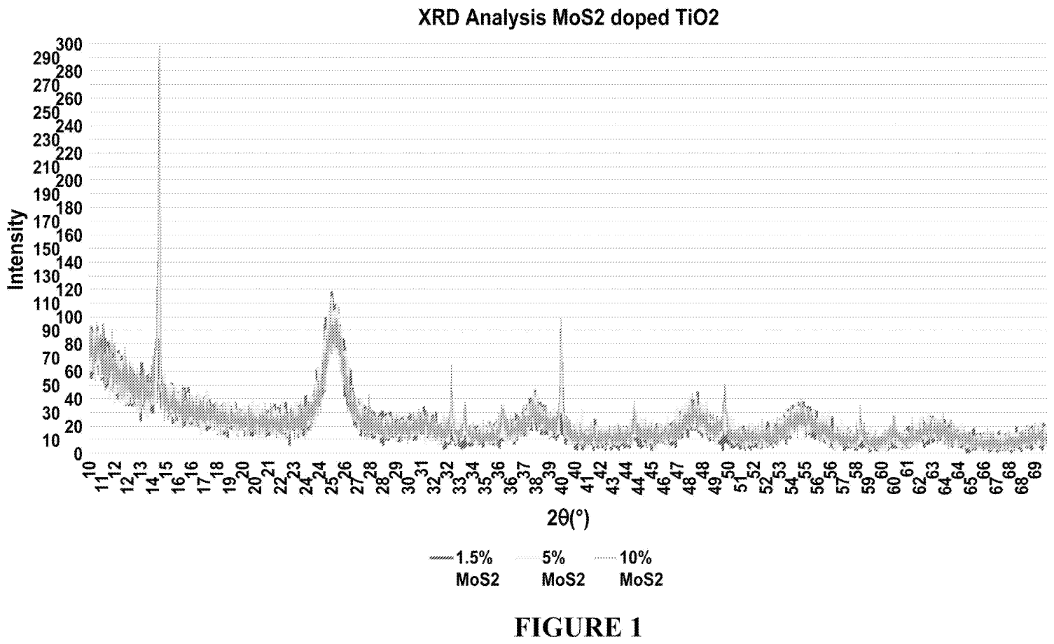

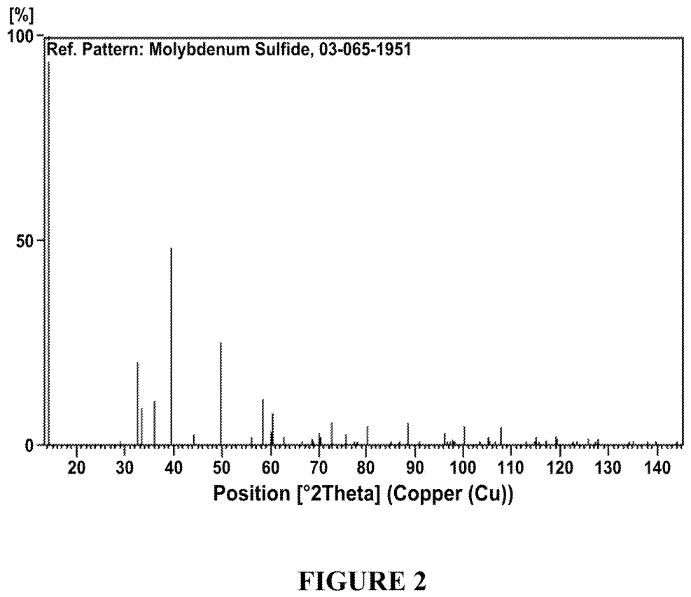

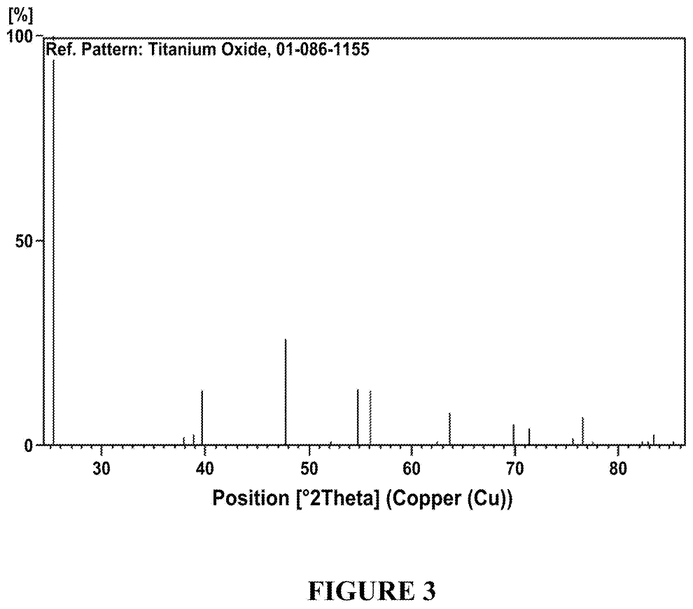

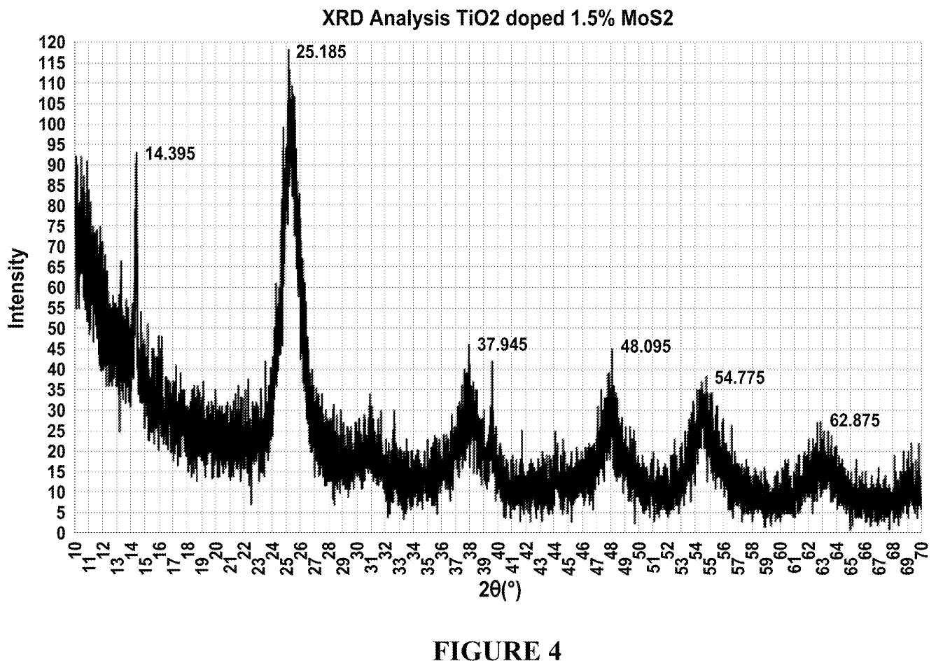

X-ray diffraction (XRD) analysis was conducted on a PANalytical X'Pert3 Powder XRD analyzer. In FIGS. 1 and 4, the XRD analysis of 1.5 wt. % MoS₂-98.5 wt. % TiO₂ nanomaterial reveals the presence of peaks characteristic of pure MoS₂ (FIG. 2) and pure TiO₂ (FIG. 3), with TiO₂ having the highest peak intensity vs. MoS₂. The wide width of the most intense TiO₂ peak at 25° indicates a small crystal size, while the narrow width of next most intense MoS₂ peak at 14° indicates a larger crystal size.

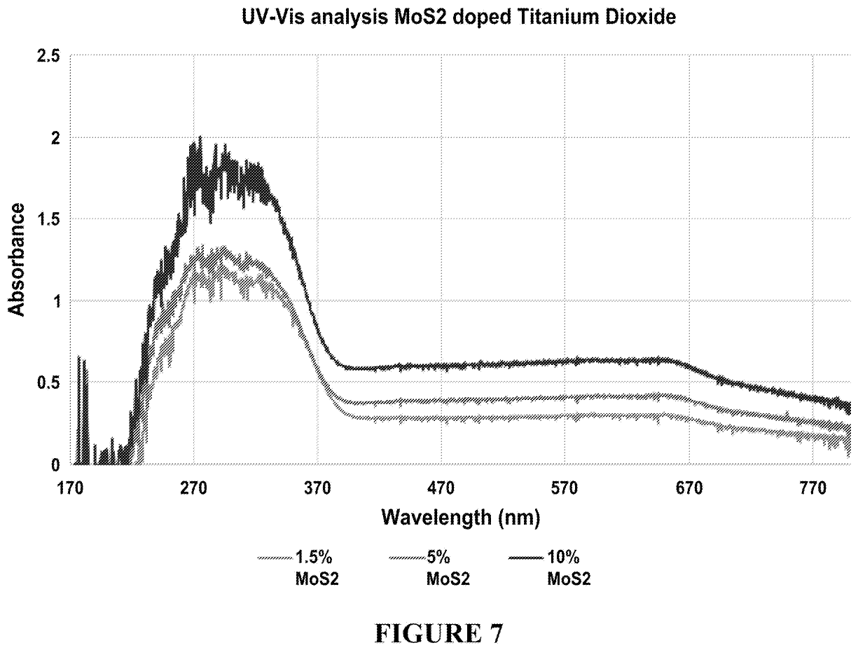

In FIG. 7, the ultraviolet-visible (UV-Vis) spectroscopic analysis of 1.5 wt. % MoS₂-98.5 wt. % TiO₂ nanomaterial reveals that MoS₂ doped TiO₂ nanomaterials display increased absorption throughout the visible spectra, compared to pure TiO₂ which has virtually no absorbance at these wavelengths. UV-Vis analysis further reveals that 1.5 wt. % MoS₂-98.5 wt. % TiO₂ nanomaterial absorbs an elevated amount of light between 220 and 380 nm, which encompasses the UVB/UVA range. Additionally, a correlation was shown between higher MoS₂ levels and increased absorbance of light in this range.

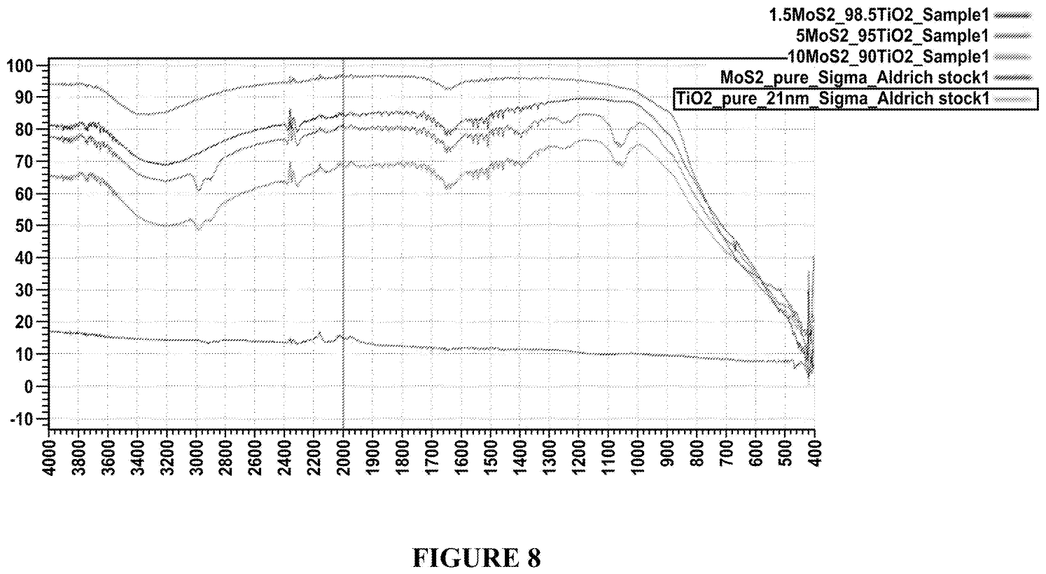

Fourier-transform infrared (FTIR) spectroscopy analysis was conducted on a Shimadzu Iraffinity-1S system coupled with a Quest ATR Diamond GS10800-X solid 20 sample analysis accessory. Standards of TiO₂ and MoS₂ were obtained by Sigma Aldrich with the MoS₂ standard being the same stock used during nanomaterial synthesis. In FIG. 8, the FTIR spectroscopy analysis of 1.5 wt. % MoS₂-98.5 wt. % TiO₂ nanomaterial reveals an absorbance across the mid-infrared range from 800-4000 cm⁻¹ intermediate between that of pure TiO₂ (a lower absorber) and pure MoS₂ (a higher absorber).

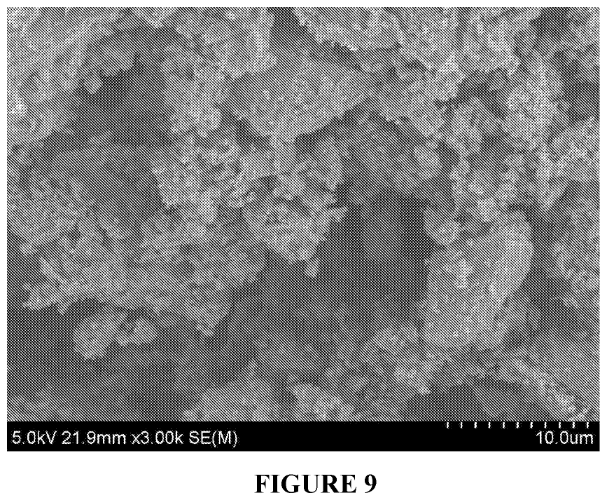

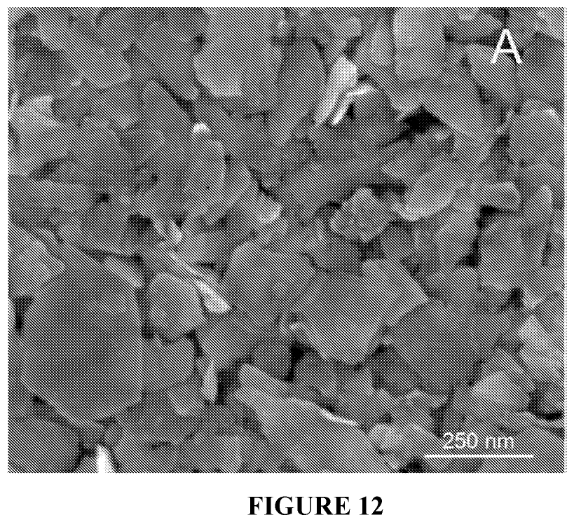

In FIG. 9, the scanning electron microscopy (SEM) readout of 1.5 wt. % MoS₂-98.5 wt. % TiO₂ nanomaterial reveals large MoS₂ mono-layered flakes in the 5-10-micrometer range, similar in appearance to MoS₂ single layer nanosheets (FIG. 12). The MoS₂ flakes are coated with an abundance of TiO₂ particles in the 1-micron range, similar in size and appearance to pure TiO₂ particles synthesized through the sol-gel method (FIG. 10).

Starting colony counts were recorded at 950 CFU/ml for bottle #1, and 1200 CFU/ml for bottle #2. These counts were well within the desired experimental range. Bottle #1 decreased most significantly in viable bacteria concentration between the 30 and 90-minute collection times, with an overall decrease of 80% viable CFU's during this period. Comparatively, bottle #2 decreased the most significantly between the 30 and 120-minute sampling window; a higher starting colony count likely led to this difference, with bottle #2 starting 250 CFU/mL higher than bottle #1. By 120 minutes both bottles contained a nearly equal number of CFU's (130 CFU/mL and 120 CFU/mL, respectively), despite differences in initial colony counts. Both bottles reached baseline by the 150-minute sampling period, with only 10 CFU/mL recorded per bottle. This demonstrates more effective results using 1.5 wt. % MoS₂-98.5 wt. % TiO₂ nanomaterial inserts for SODIS versus SODIS without the use of nanomaterial inserts and equivalent results versus SODIS using pure TiO₂ nanomaterial inserts. The results are shown in FIG. 22 and Table 1.

### Example 2: 5 wt. % MoS₂-95 wt. % TiO₂ Nanomaterial

MoS₂—TiO₂ nanomaterial was prepared by the method of example 1 except that 730 ml anhydrous 2-propanol, 2 g (12.5 mmol) MoS₂ powder, and 141 mL Ti[OCH(CH₃)₂]₄ (476 mmol) were used. The actual yield was 38.1 g (95%).

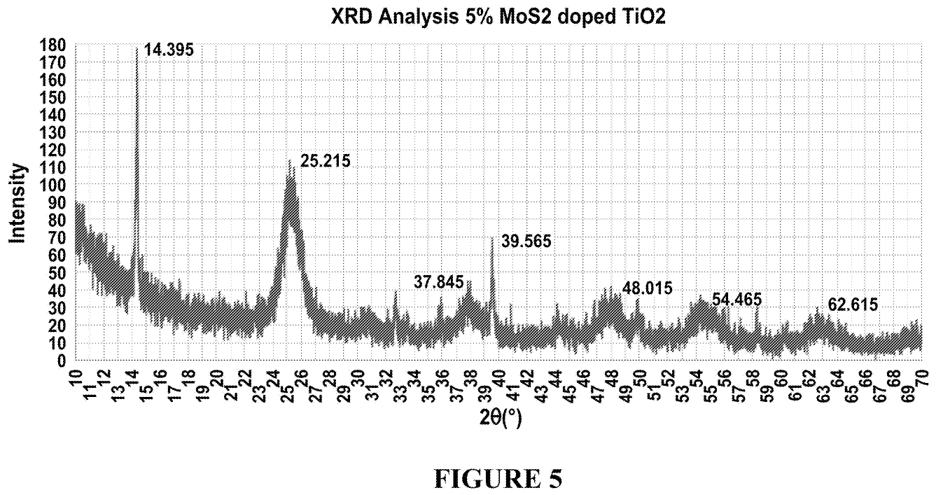

X-ray diffraction (XRD) analysis was conducted on a PANalytical X'Pert₃ Powder XRD analyzer. In FIGS. 1 and 5, the XRD analysis of 5 wt. % MoS₂-95 wt. % TiO₂ nanomaterial reveals the presence of peaks characteristic of pure MoS₂ (FIG. 2) and pure TiO₂ (FIG. 3), although in contrast with Example 1, it is the MoS₂ peak which has the highest peak intensity vs. TiO₂. However, the peak widths are the same as those observed for Example 1. The narrow MoS₂ peak at 14° indicates a larger crystal size, while the wide TiO₂ peak at 25° indicates a small crystal size.

In FIG. 7, the UV-Vis spectroscopic analysis of 5 wt. % MoS₂-95 wt. % TiO₂ nanomaterial reveals that MoS₂ doped TiO₂ nanomaterials display increased absorption throughout the visible spectra, compared to pure TiO₂ which has virtually no absorbance at these wavelengths. UV-Vis analysis further reveals that 5 wt. % MoS₂-95 wt. % TiO₂ nanomaterial absorbs an elevated amount of light between 220 and 380 nm, which encompasses the UVB/UVA range. Additionally, a correlation was shown between higher MoS₂ levels and increased absorbance of light in this range.

Fourier-transform infrared (FTIR) spectroscopy analysis was conducted on a Shimadzu Iraffinity-1S system coupled with a Quest ATR Diamond GS10800-X solid 20 sample analysis accessory. Standards of TiO₂ and MoS₂ were obtained by Sigma Aldrich with the MoS₂ standard being the same stock used during nanomaterial synthesis. In FIG. 8, the FTIR spectroscopy analysis of 5 wt. % MoS₂-95 wt. % TiO₂ nanomaterial reveals an absorbance across the mid-infrared range from 800-4000 cm⁻¹ intermediate between that of pure TiO₂ (a lower absorber) and pure MoS₂ (a higher absorber). Further, analysis revealed a direct correlation between higher MoS₂ levels and increased absorbance from 800-4000 cm⁻¹.

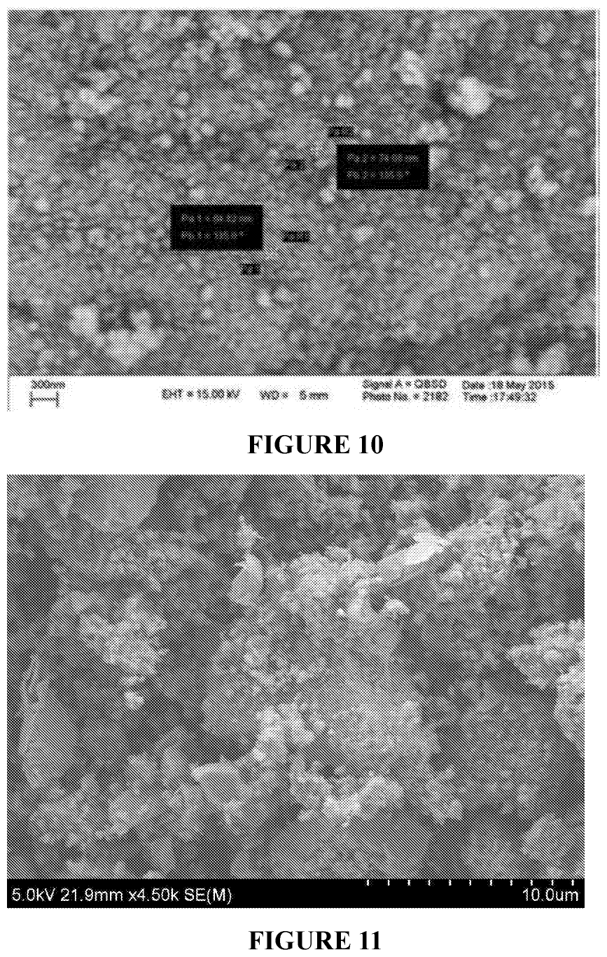

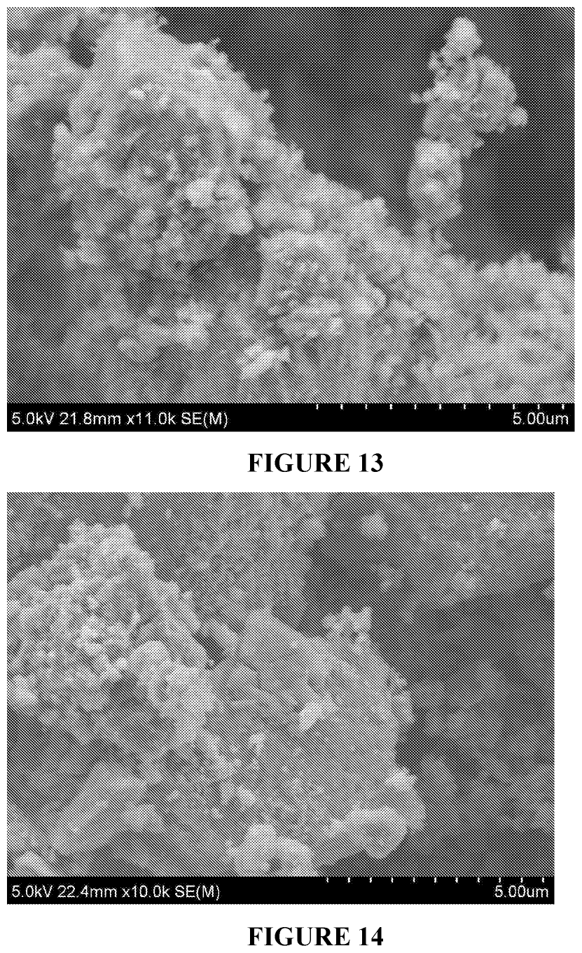

In FIGS. 11 and 13, the SEM readout of 5 wt. % MoS₂-95 wt. % TiO₂ nanomaterial reveals MoS₂ mono-layered flakes in the 4-5-micron range, similar in appearance to MoS₂ single layer nanosheets (FIG. 12). The MoS₂ flakes are uniformly coated with TiO₂ particles in the 1-micrometer range, similar in size and appearance to pure TiO₂ particles synthesized through the sol-gel method (FIG. 10). However, the distribution of sizes of MoS₂ flakes is much wider than observed for the nanomaterials of Example 1.

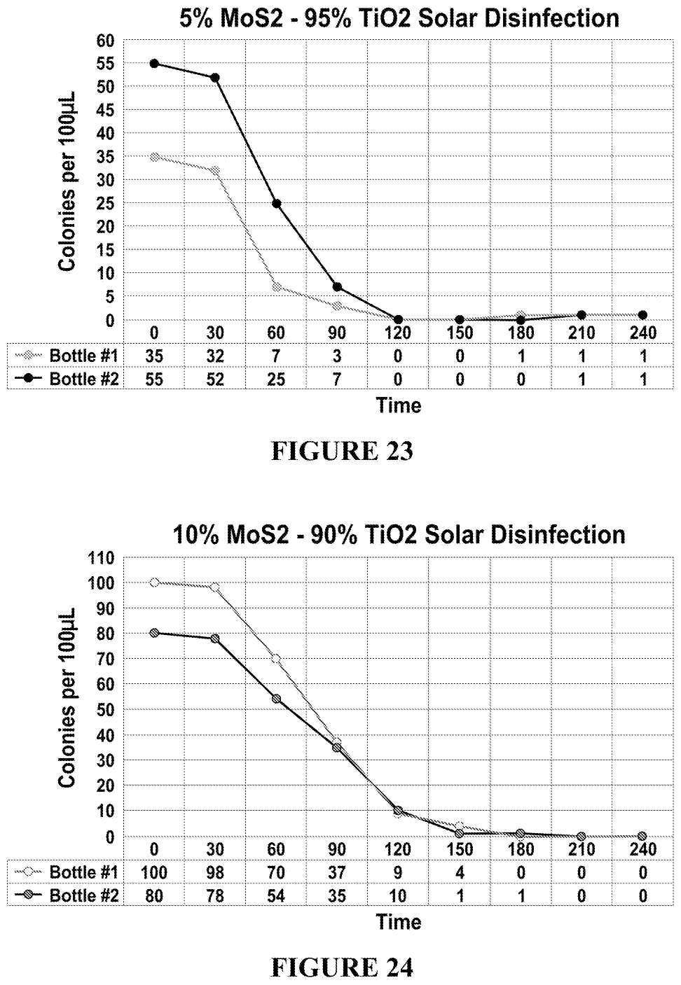

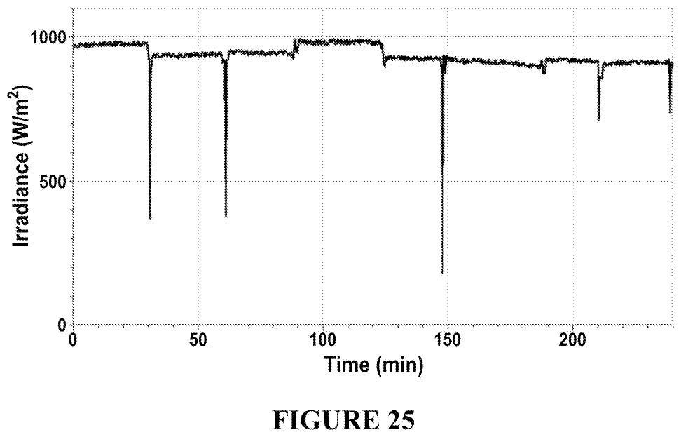

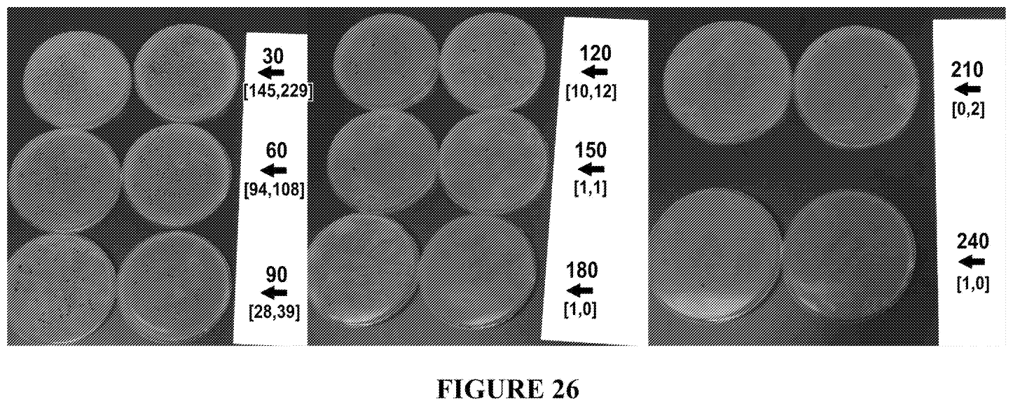

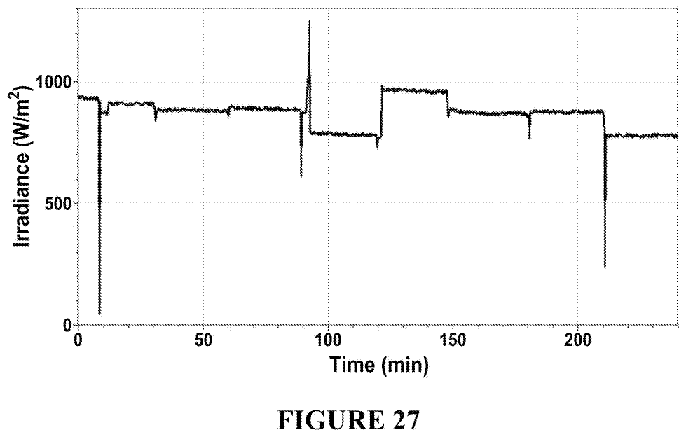

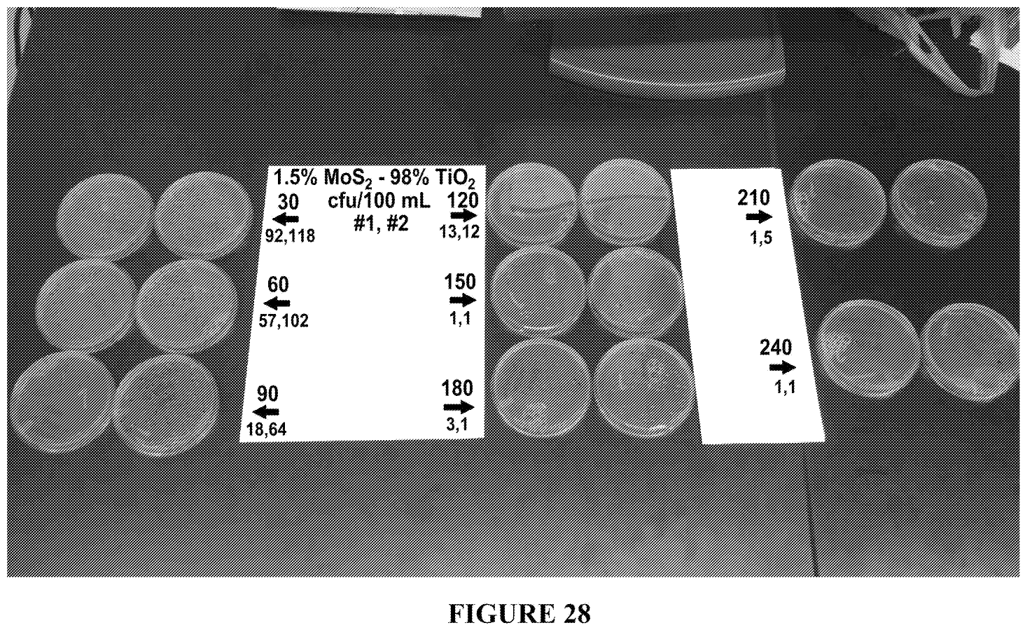

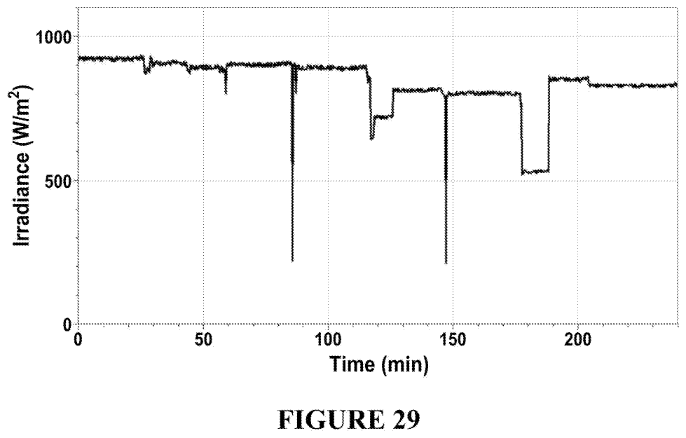

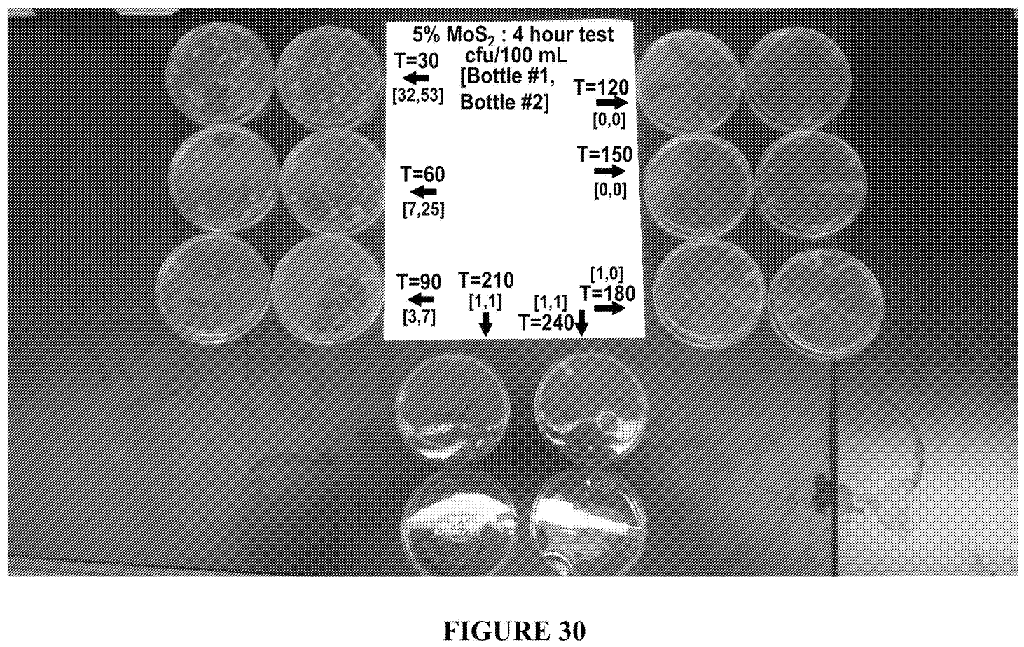

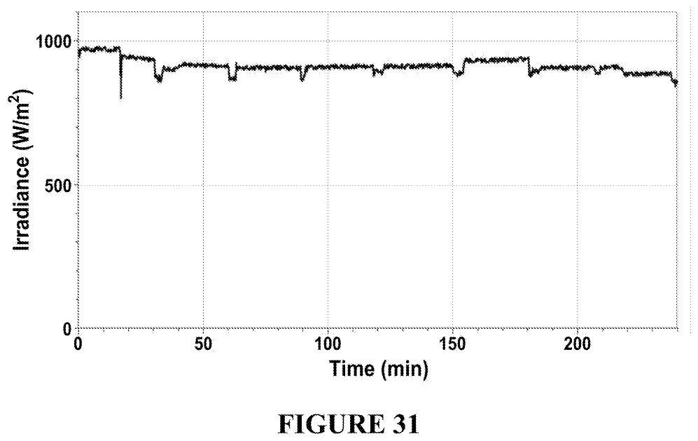

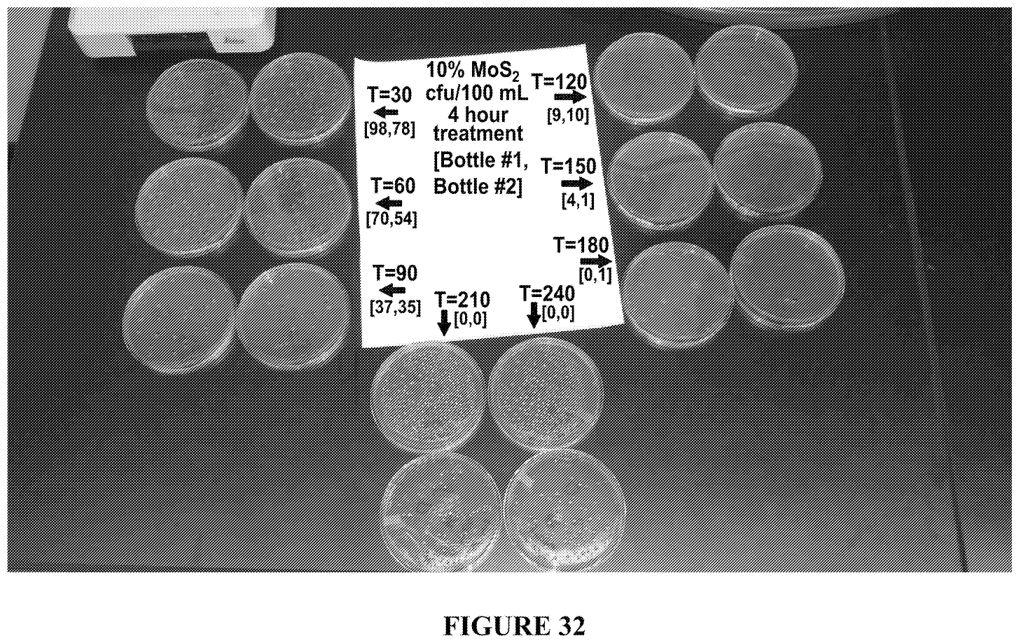

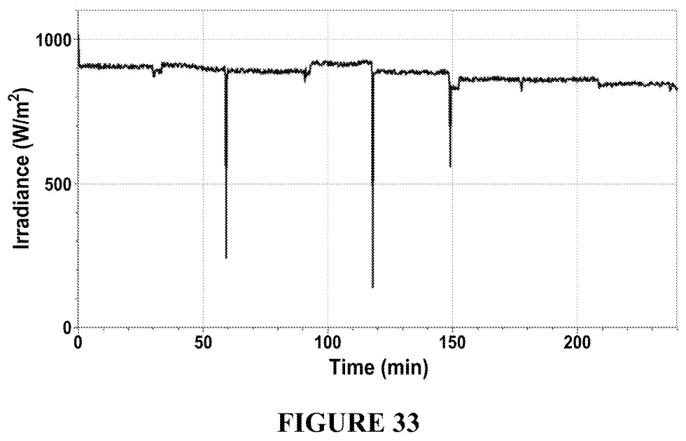

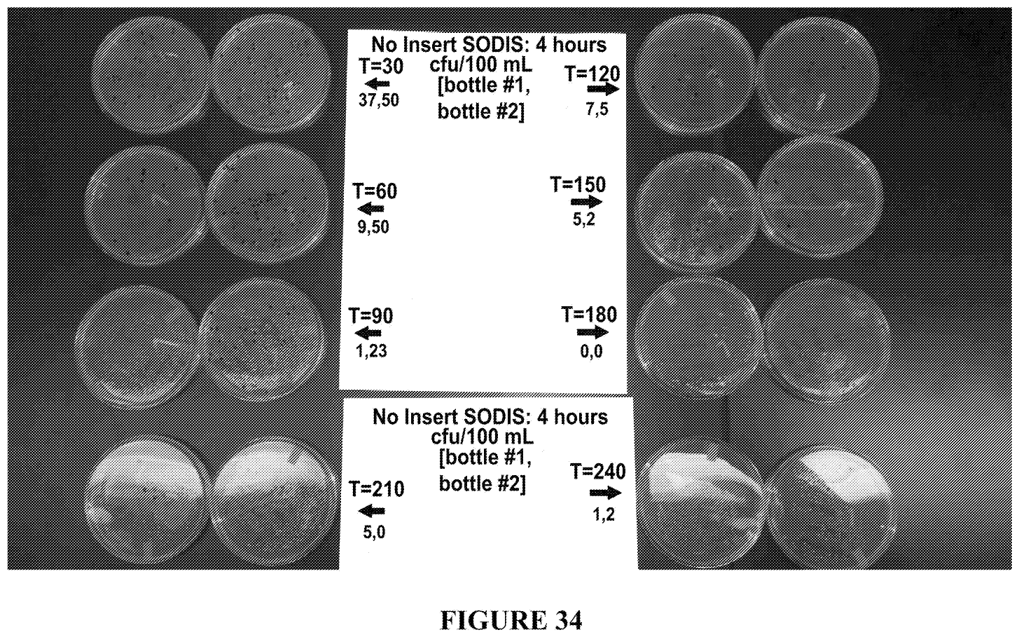

A starting colony count of 350 CFU/mL was recorded for bottle #1, and 550 CFU/mL for bottle #2. These counts were well within the desired experimental range. Bottle #1 experienced the highest decrease in viable colonies between 30 and 60 minutes, with a 52% decrease between sampling windows. In contrast, bottle #2 experienced its greatest decrease in concentration between the 30 to 90 minute sampling times, dropping from 520 CFU/mL to 70 CFU/mL. By 90 minutes bottle #1 registered a colony count of 30 CFU/mL, with bottle two at 70 CFU/mL. Comparatively, it took the bottles with no insert 60 minutes longer (150-minute sampling window) to reach the same levels of E. coli inactivation. By the 120-minute mark, both bottles reached a viable colony count of 0, with no rebound afterwards. This example completely disinfected the sample by the 120-minute sampling window. This demonstrates more effective results using 5 wt. % MoS₂-95 wt. % TiO₂ nanomaterial inserts for SODIS versus either SODIS with pure TiO₂ nanomaterial inserts or without the use of nanomaterial inserts. The results are shown in FIG. 23 and Table 1.

### Example 3: 10 wt. % MoS₂-90 wt. % TiO₂ Nanomaterial

MoS₂—TiO₂ nanomaterial was prepared by the method of example 1 except that 668 ml anhydrous 2-propanol, 4 g (25 mmol) MoS₂ powder, and 133.5 mL Ti[OCH(CH₃)₂]₄ (451 mmol) were used. The actual yield was 38.7 g (97%).

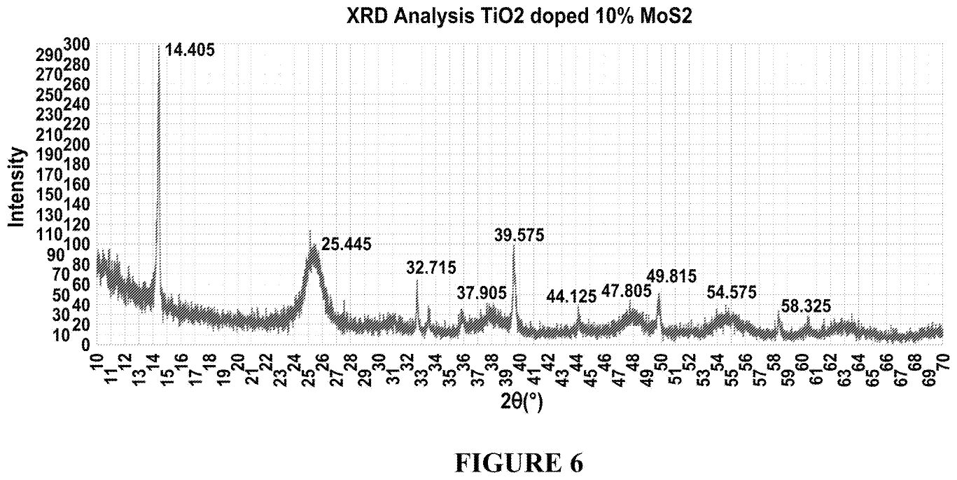

X-ray diffraction (XRD) analysis was conducted on a PANalytical X'Pert3 Powder XRD analyzer. In FIGS. 1 and 6, the XRD analysis of 10 wt. % MoS₂-90 wt. % TiO₂ nanomaterial reveals the presence of peaks characteristic of pure MoS₂ (FIG. 2) and pure TiO₂ (FIG. 3), consistent with Example 2, where it is the MoS₂ peak which has the highest peak intensity vs. TiO₂. However, the peak widths are the same as those observed for Example 1. The narrow MoS₂ peak at 14° indicates a larger crystal size, while the wide TiO₂ peak at 25° indicates a small crystal size.

In FIG. 7, the UV-Vis spectroscopic analysis of 10 wt. % MoS₂-90 wt. % TiO₂ nanomaterial reveals that MoS₂ doped TiO₂ nanomaterials display increased absorption throughout the visible spectra, compared to pure TiO₂ which has virtually no absorbance at these wavelengths. UV-Vis analysis further reveals that 10 wt. % MoS₂-90 wt. % TiO₂ nanomaterial absorbs an elevated amount of light between 220 and 380 nm, which encompasses the UVB/UVA range. Additionally, the 10 wt. % MoS₂-90 wt. % TiO₂ nanomaterial absorbed approximately 50-60% more in the UVB/UVA range than the nanomaterial of Example 2.

Fourier-transform infrared (FTIR) spectroscopy analysis was conducted on a Shimadzu Iraffinity-1S system coupled with a Quest ATR Diamond GS10800-X solid 20 sample analysis accessory. Standards of TiO₂ and MoS₂ were obtained by Sigma Aldrich with the MoS₂ standard being the same stock used during nanomaterial synthesis. In FIG. 8, the FTIR spectroscopy analysis of 10 wt. % MoS₂-90 wt. % TiO₂ nanomaterial reveals an absorbance across the mid-infrared range from 800-4000 cm⁻¹ intermediate between that of pure TiO₂ (a lower absorber) and pure MoS₂ (a higher absorber). Further, analysis revealed a direct correlation between higher MoS₂ levels and increased absorbance from 800-4000 cm⁻¹.

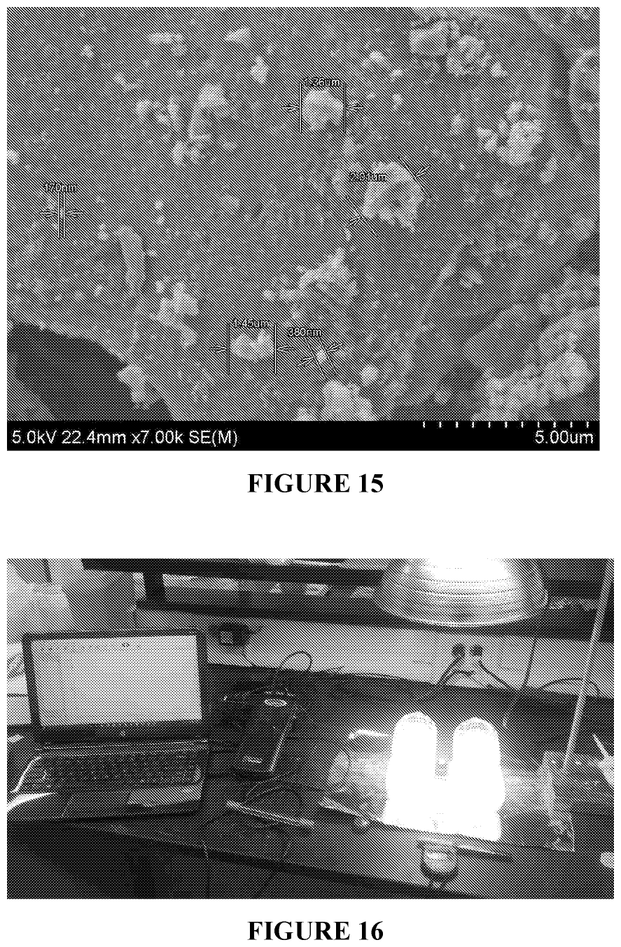

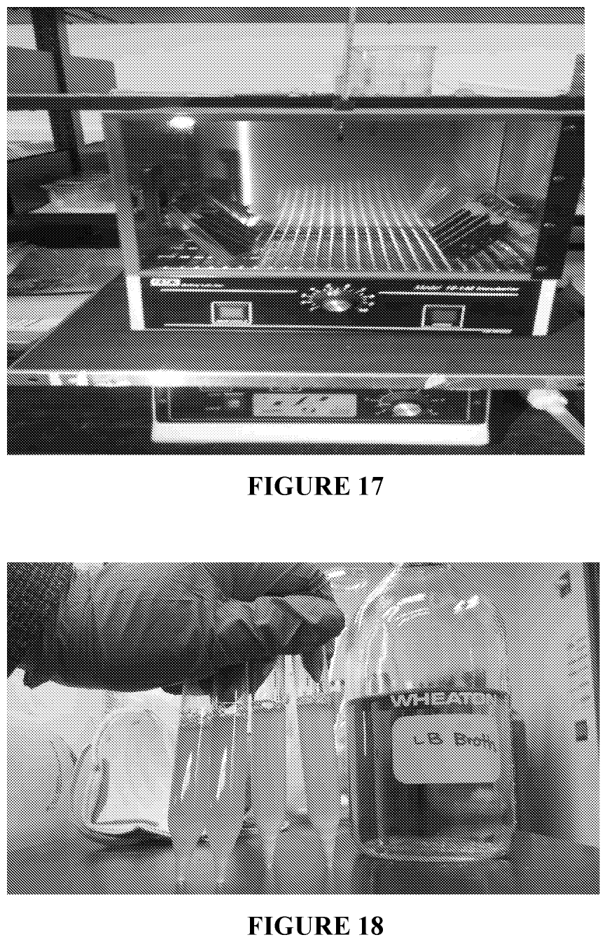

In FIG. 14, the SEM readout of 10 wt. % MoS₂-90 wt. % TiO₂ nanomaterial reveals a broad distribution of MoS₂ mono-layered flakes up to about 5-microns, similar in appearance to MoS₂ single layer nanosheets (FIG. 12). The MoS₂ flakes are coated with TiO₂ particles in the 1-micron range, similar in size and appearance to pure TiO₂ particles synthesized through the sol-gel method (FIG. 10). However, the size of the MoS₂ flakes are larger than the 5-micron average for nanomaterials of Examples 1 and 2. Further, the TiO₂ coverage of MoS₂ flakes is not as uniform as observed for nanomaterials of Examples 1 and 2. Finally, FIG. 15 reveals a wider TiO₂ particle size distribution than for nanomaterials of Examples 1 and 2.

Starting colony counts were recorded at 1000 CFU/mL for bottle #1, and 800 CFU/mL for bottle #2. These counts were well within the 300 to 3000 CFU/mL desired range. Both bottles displayed the greatest decreases in concentration between the 30-minute and 120-minute sampling periods. Bottle #1 demonstrated a 90% reduction in viable colonies between these time periods, with bottle #2 an 87% reduction within the same time. By 120 minutes, total viable CFU's had dropped down to 90 CFU/mL and 100 CFU/mL for bottles #1 and #2, respectively. Near complete inactivation of bacteria occurred at the 150-minute mark. This demonstrates more effective results using 10 wt. % MoS₂-90 wt. % TiO₂ nanomaterial inserts for SODIS versus SODIS without the use of nanomaterial inserts and equivalent results versus SODIS using pure TiO₂ nanomaterial inserts. The results are shown in FIG. 24 and Table 1.

TABLE 1
Summary of percent decrease in bacterial count by time period

| | | | | | Time to baseline |
|---|---|---|---|---|---|
| T-T+30 | 30-60 | 60-90 | 90-120 | 120-150 | (zero colony |
| min | min | min | min | min | count) min |
| No catalyst | 38% | 72% | 339% (increase) | 45% | 240+30 |
| Pure TiO2 | 45% | 67% | 67% | 91% | 150 |
| 1.5 wt. % MoS2 | 26% | 53% | 55% | 92% | 150 |
| 98.5 wt.% TiO2 | | | | | |
| 5 wt. % MoS2 | 65% | 65% | 100% | 120 | |
| 95 wt.% TiO2 | | | | | |
| 10 wt. % MoS2 | 30% | 41% | 14% | 73% | 150 |
| 90 wt.% TiO2 | | | | | |

The particles and methods of the appended claims are not limited in scope by the specific particles and methods described herein, which are intended as illustrations of a few aspects of the claims and any particles and methods that are functionally equivalent are intended to fall within the scope of the claims. Various modifications of the particles and methods in addition to those shown and described herein are intended to fall within the scope of the appended claims. Further, while only certain representative particles and method steps disclosed herein are specifically described, other combinations of the particles and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A particle comprising: a core and a shell at least partially surrounding the core, wherein the core comprises a transition metal dichalcogenide and the shell comprises a transition metal oxide.

2. The particle according to claim 1, wherein the transition metal dichalcogenide has the formula MX₂, wherein M is Ti, Mo, In, W, Fe, Mn, Pd, Ta, Zr, or Cu, and wherein X is O, S, Se, Te, or a combination thereof.

3. The particle according to claim 1, wherein the transition metal dichalcogenide is MoS₂.

4. The particle according to claim 1, wherein the transition metal oxide is TiO₂.

5. The particle according to claim 1, wherein: the core comprises 10 wt. % or less of the particle; and/or the shell comprises 90 wt. % or greater of the particle.

6. (canceled)

7. (canceled)

8. (canceled)

9. The particle according to claim 1, wherein the core is a mono-layered flake having a longest dimension from about 1 to about 20 micrometers.

10. (canceled)

11. The particle according to claim 1, wherein the shell is a layer comprising particles, preferably microparticles.

12. The particle according to claim 11, wherein the particles have a particle size of from about 50 nm to about 2 microns.

13. A method of producing a particle according to claim 1, comprising:
contacting a transition metal alkoxide with a suspension comprising a transition metal dichalcogenide, thereby forming a sol-gel precursor solution; and
acidifying the suspension, thereby at least partially surrounding the transition metal dichalcogenide with a shell comprising the transition metal oxide.

14. (canceled)

15. The method of claim 13, wherein the transition metal alkoxide is Ti[OCH(CH₃)₂]₄.

16. The method of claim 13, further comprising an initial step, occurring prior to contacting the transition metal alkoxide with the suspension, comprising:
sonicating the suspension comprising a transition metal dichalcogenide in a solvent and a surfactant, thereby forming a suspension of transition metal dichalcogenide monolayers.

17. The method of claim 16, wherein: the solvent is anhydrous 2-isopropanol; and the surfactant is polystyrene sulfonate, cetrimonium bromide, dimethyldioctylammonium chloride, polydodecylsulfonate, cetylpyridinium chloride, or a polyacid.

18. (canceled)

19. (canceled)

20. (canceled)

21. (canceled)

22. The method of claim 13, further comprising drying and annealing the particle.

23. The method of claim 13, further comprising milling the particle.

24. An article comprising: the particles of claim 1; a support; and an adhesive layer positioned between the support and the particle.

25. The article of claim 24, wherein: the support is an acetate film; and/or the adhesive layer is polyester resin, silicone resin, epoxy resin, vulcanized rubber, polyurethane resin, or high-density polyethylene.

26. A method of reducing microbial contamination comprising: contacting a contaminated sample with the particles of claim 1 and light.

27. (canceled)

28. The method of claim 26, wherein the microbial contamination is reduced by: at least 25% within 60 minutes.

29. (canceled)

30. (canceled)

31. (canceled)

32. The method of claim 26, wherein the microbial contamination includes bacteria.

33. (canceled)

34. (canceled)

35. (canceled)

36. (canceled)

37. (canceled)

38. A method of producing an article comprising:
coating a support with a layer of adhesive;
coating the adhesive layer with the particles of claim 1; and
curing the article in the dark.

39. (canceled)
